(19) United States
(12) Patent Application Publication
(10) Pub. No.: US 2013/0298356 A1
(43) Pub. Date: Nov. 14, 2013

(54) CORD MANAGEMENT SYSTM

(71) Applicant: Matt Scandora, Chicago, IL (US)

(72) Inventor: Matt Scandora, Chicago, IL (US)

(73) Assignee: Flux Audio LLC, Chicago, IL (US)

(21) Appl. No.: 13/890,630

(22) Filed: May 9, 2013

Related U.S. Application Data
(60) Provisional application No. 61/645,394, filed on May 10, 2012.

(51) Int. Cl. F16B 1/00

(52) U.S. Cl. CPC F16B 1/00
USPC 24/303

(57) ABSTRACT

A headphone cord management system comprised of a plurality of small magnets attached to and spaced along a length of the headphone cord. Where the cord may split for separate ear pieces, the magnets along the two lines preferably align to bring the two lines together when not in use. The magnets allow the cord to be coiled and looped in different ways to facilitate carrying and storage.

### RELATED APPLICATION

The present application claims the filing priority of U.S. Provisional Application No. 61/645,394 titled “Cord Management System” and filed on May 10, 2012. The '394 application is hereby incorporated by reference.

### TECHNICAL FIELD OF THE INVENTION

The present device relates to a system for managing a cord including, for example, an earphone cord, charging cord, and the like. Particularly, the present device relates to both an original equipment cord managing system and a retrofit system for existing cords to prevent tangling.

### BACKGROUND OF THE INVENTION

Cord management typically refers to devices and systems which help keep electrical cords for lighting, computers, appliances, etc. from becoming unsightly or a tripping hazard. With more and more people using earphones these days for phones and other electronic devices, management of earphone cords has also become a significant issue.

Like other cords, earphone cords have two free ends which can easily become looped and tied, twisted and knotted with just a small amount of inattention. Further, most earphone cords have a split at one end giving them three free ends with the potential for creating an even bigger knotted mess.

The present invention solves these and other problems associated with the use and storage of cords, particularly headphone cords.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an embodiment of the present earphone cord management system;

FIGS. 2a and 2b are plan views showing the embodiment of FIG. 1 in a coiled-state;

FIG. 3 is an illustration of the embodiment of FIG. 1 in use;

FIG. 4 is an illustration of the embodiment of FIG. 1 showing the earphone cord in a temporary storage position;

FIG. 5 is an illustration of the embodiment of FIG. 1 showing the earphone cord in another temporary storage position; and

FIG. 6 is an illustration of the embodiment of FIG. 1 showing the earphone cord in a third temporary storage position.

### DETAILED DESCRIPTION OF PREFERRED EMBODIMENTS

While this invention is susceptible of embodiments in many different forms, there is shown in the drawings and will herein be described in detail a preferred embodiment of the invention with the understanding that the present disclosure is to be considered as an exemplification of the principles of the invention and is not intended to limit the broad aspect of the invention to embodiments illustrated.

While the cord management system 10 is only illustrated on a set of personal earphones, it should be understood that the inventiveness of the system 10 has far more potential uses. For example, the broad concept may be applied to unrelated devices such as computer cords, printer cords, speaker wires, cords for light fixtures and other corded household electric devices.

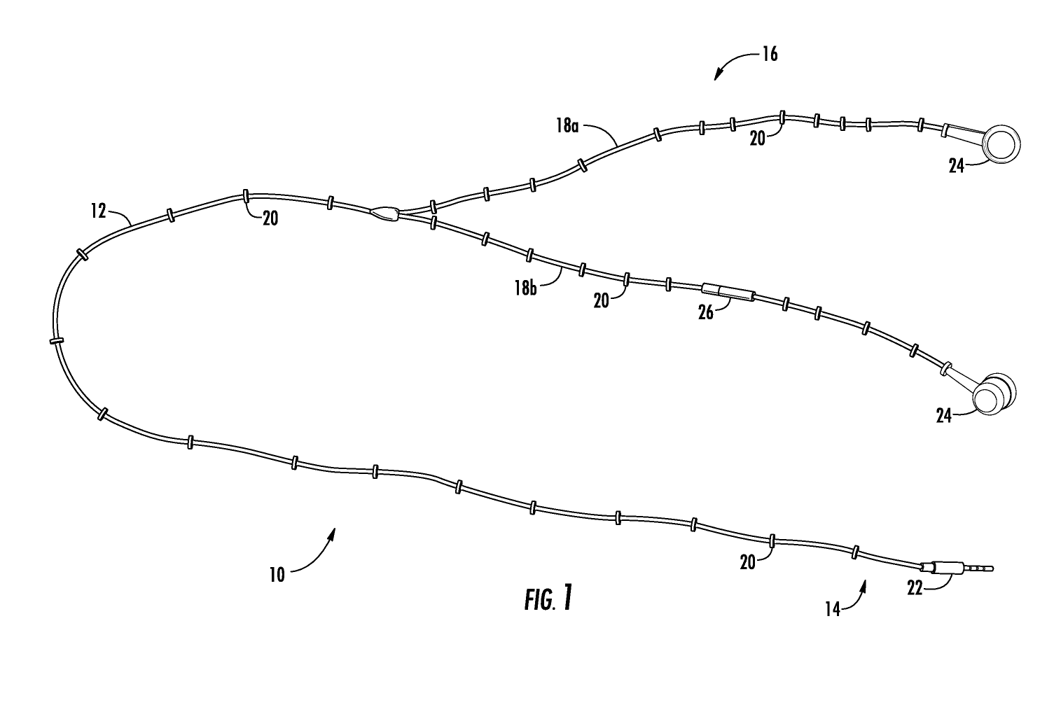

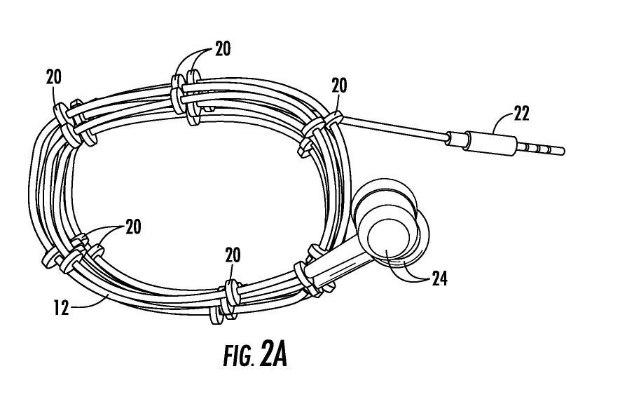

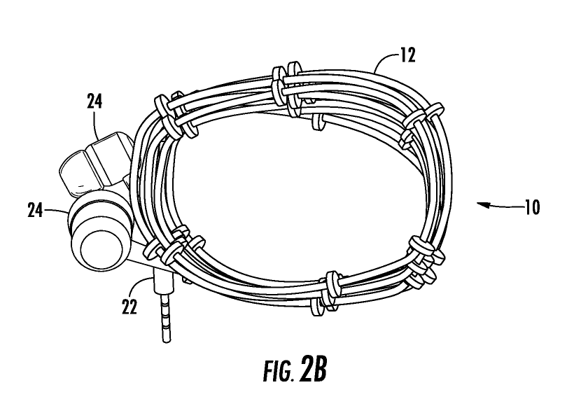

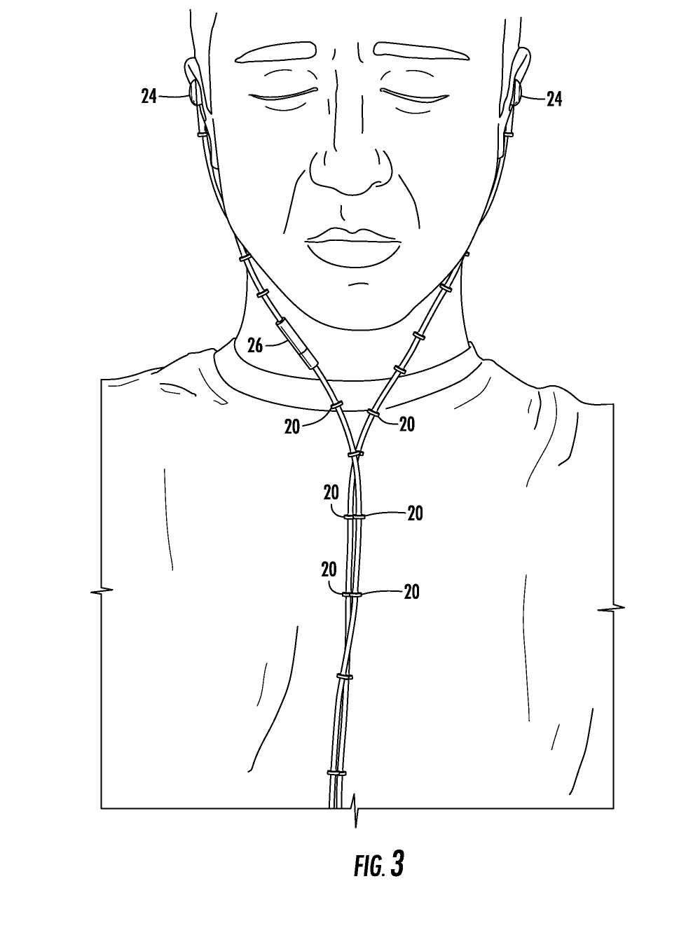

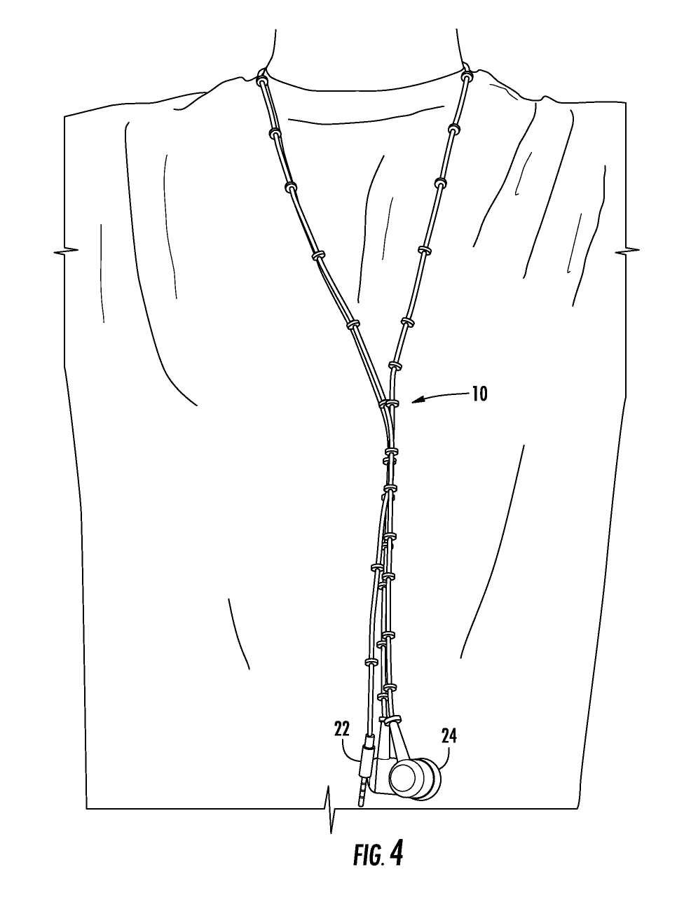

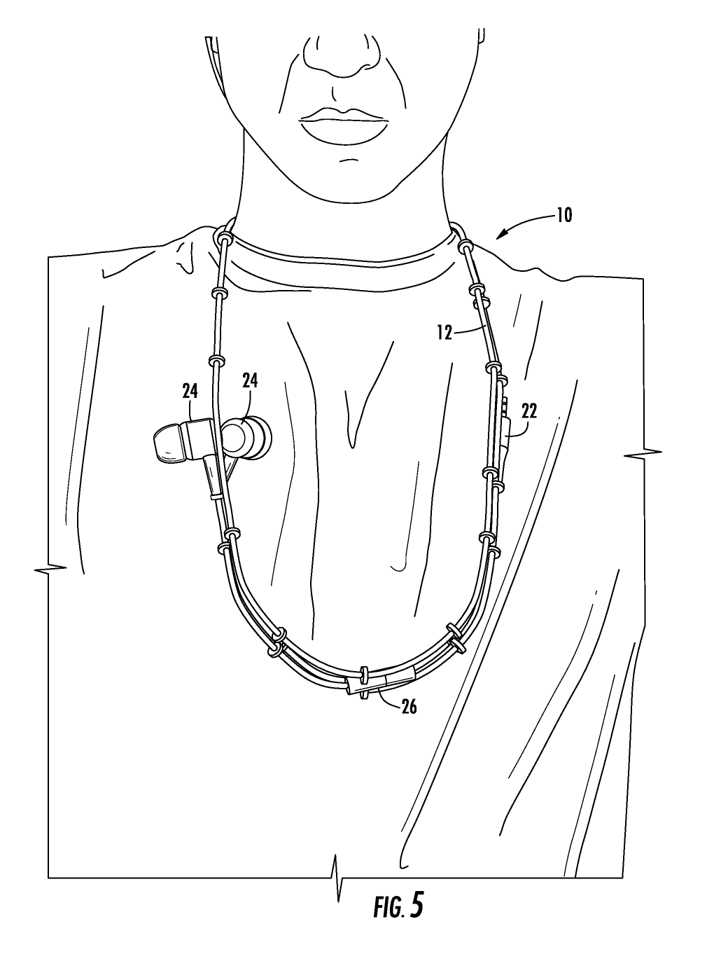

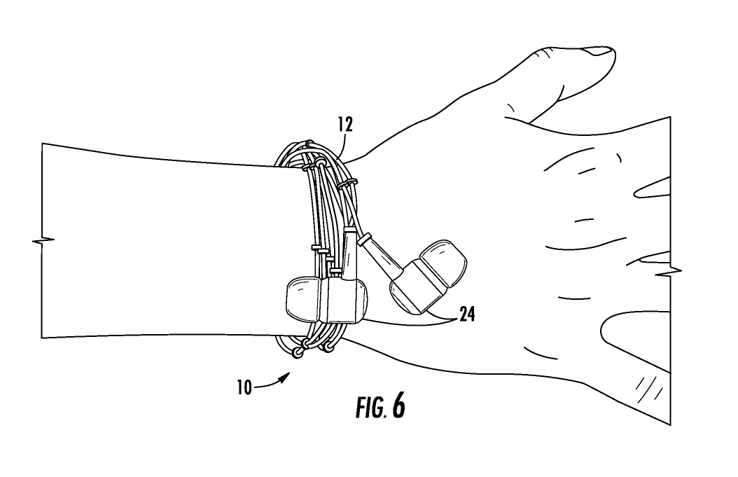

Referring to FIGS. 1-6, there is illustrated a cord management system, generally designated by the numeral 10. The management system 10 is comprised of an earphone cord 12 having a first end 14 and a second end 16, and a plurality of magnets 20 uniquely attached to the cord 12. The second end 16 of cord 12 is itself split into two lines 18a, b to form a Y-shape with the first end 14. The first end 14 includes a standard jack 22 for connection to an electronic device (not shown), such as an MP3 player, and the second end 16 includes an ear speaker device 24 at the end of each line 18a, b for delivering sound into a user's ear. A microphone device 26 may be attached to and positioned on one of the two split lines 18a, b as well.

As shown, along the length of the cord 12, spaced about every inch or so, is positioned several magnets 20, preferably small neodymium magnets which are very resistive to demagnetization. Of course, other types of magnets may be used and the spacing can be altered to best suit a particular use, if desired. The illustrated embodiment uses similar sized magnets 20. However, two different magnet sizes may be used, with smaller magnets used in pairs along the split lines 18a, b and slightly larger sized magnets being attached to the cord 12 from the point of the split toward the first end 14.

The magnets 20 used on the split wire are preferably aligned in pairs to bring the two wires 18a, b together when not in use or as desired to prevent the cords from catching on other objects. Additionally, the magnets 20 will also allow attachment of the cord 12 to most any ferrous metal surface or object.

The magnets 20 may be permanently or temporarily attached to the cord 12. That is, the cord management system 10 may be manufactured with the magnets 20 assembled onto cord 12 or an existing cord may be retrofitted with the magnets 20. Further, a thin protective material, such as a clear or colored sheathing (not shown) may be used to cover each of the magnets 20 separately to prevent damage to the same.

As shown, the present cord management system 10 allows the cord 12 to be stored in various ways on the user—e.g., wrapped about a wrist, looped around a neck—or in a coil on its own. All the while the cord 12 is prevented from becoming tangled and knotted.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A cord management system comprising:
a flexible headphone cord having a first end including a male plug connector and a second end which is split into two lines to form a Y and including a speaker device attached to each of the two lines; and
a plurality of magnets attached to and spaced along the cord, including the split lines where the position of magnets align with one another.

2. The cord management system of claim 1, wherein the magnets are permanently affixed to the cord.

3. The cord management system of claim 1, wherein the magnets are retrofitted to an existing cord.

4. The cord management system of claim 1, wherein the plurality of magnets comprise at least one magnet pair of a first size and at least one magnet of a second size.

5. The cord management system of claim 4, wherein the at least one magnet pair of a first size are smaller than the at least one magnet of a second size.

6. The cord management system of claim 5, wherein each of the magnets of the at least one magnet pair of a first size are positioned on one of the two lines of the cord and the at least one magnet pair of a second size are positioned on the headphone cord before the split lines.

7. The cord management system of claim 6, wherein magnet pairs on the two lines are aligned.

8. A method for preventing a headphone cord from tangling during use and storage, the method comprising the steps of:
providing a set of headphones comprising a cord having a first end for plugging into an audio device and a second end having two diverging lines, each with an speaker device attached thereto for placement within a user's ear;
affixing a plurality of magnets on the cord at spaced intervals.

9. The method of claim 8, wherein the step of affixing a plurality of magnets on the cord comprises the step of attaching at least one magnet pair of a first size and at least one magnet of a second size.

10. The method of claim 9, wherein the at least one magnet pair of a first size are smaller than the at least one magnet of a second size.

11. The method of claim 10, further comprising the steps of affixing the at least one magnet pair of a first size on the two lines of the cord and affixing the at least one magnet of a second size on the headphone cord before the split lines.

12. A cord management system comprising:
a flexible cord having a first end and a second end; and
a plurality of magnets attached to and spaced along the cord.

13. The cord management system of claim 12, wherein the magnets are permanently affixed to the cord.

14. The cord management system of claim 12, wherein the magnets are retrofitted to an existing cord.

15. The cord management system of claim 12, wherein the plurality of magnets comprise at least one magnet of a first size and at least one magnet of a second size.

16. The cord management system of claim 15, wherein the at least one magnet of a first size are smaller than the at least one magnet of a second size.
